(19) United States
(12) Patent Application Publication
(10) Pub. No.: US 2017/0276778 A1
(43) Pub. Date: Sep. 28, 2017

(54) EMCW LAYER THICKNESS MEASUREMENT APPARATUS AND METHOD

(71) Applicant: SYSMETRIC LTD., Afula llit (IL)

(72) Inventors: Gili Gozni, Givat HaEla (IL); Shaike Maoz, Karkur (IL)

(73) Assignee: Sysmetric Ltd.

(21) Appl. No.: 15/528,574

(22) PCT Filed: Jan. 7, 2016
(86) PCT No.: PCT/IL2016/050017

§ 371 Date: May 22, 2017

Related U.S. Application Data
(60) Provisional application No. 62/100,923, filed on Jan. 8, 2015.

(51) Int. Cl. G01S 13/32

(52) U.S. Cl. CPC G01S 13/32

(57) ABSTRACT

A method is provided for measuring a distance to a surface of an object using an electromagnetic continuous wave (EMCW). The method comprises obtaining an estimation d_{E} of the distance to the surface. The method further comprises generating an electromagnetic continuous wave (EMCW) having a frequency in the range between about 100 MHz and about 1 THz, wherein the EMCW is frequency modulated so that the frequency thereof is controllably varied and transmitting a measurement portion of the EMCW towards the surface of the object. The method further comprises receiving a received signal from a reflection of the transmitted EMCW from the surface of the object and generating a combined signal by combining the received signal with a delayed signal, the delayed signal being obtained by delaying a reference portion of the EMCW by a controllably variable time delay ΔT, ΔT being dictated by d_{E}. The method further comprises measuring a parameter of the combined signal, thereby measuring the distance to the surface of the object.

### FIELD OF THE INVENTION

The invention, in some embodiments, relates to the field of layer thickness measurements and more particularly, but not exclusively, to thickness measurements of layers of electrically isolating materials using frequency modulated, continuous electromagnetic waves.

### BACKGROUND OF THE INVENTION

A layer thickness measurement may come important in many industrial applications, for instance in quality assurance and control of production lines. In production lines of items such as plates, sheets, pipes or coated products, parameters such as absolute layer thickness and variation of layer thickness (e.g. variations between different areas of the same item, or variations between items) are directly related to the absolute quantity of raw material used in the manufacturing process and to adequacy of the item characteristics (such as evenness, symmetry, strength etc.) to the item's required specifications.

Several methods and technologies are currently known and employed for thickness measurements of polymeric layers. These include technologies that utilize ionizing radiation, such as Gamma, Beta and X-ray radiation; ultrasound; optical methods using e.g. laser or IR radiation; and various methods that utilize high frequency or low frequency electromagnetic radiation.

FMCW systems are well known and are being widely used for distance measurements. For example, FMCW systems have been used for altitude measurements of airplanes above ground in a range between a few meters and a few kilometers. In such systems the range to a target is measured by continuously varying the frequency of a transmitted electromagnetic wave and comparing the frequency of the transmitted wave to the frequency of a received wave that is reflected back from the target. For example a triangular or saw-tooth frequency sweep is implemented so that the transmitted frequency varies linearly with time. The frequency difference between the transmitted signal and the signal reflected back from the target is a measure of the time lapse of the reflected signal, and thus of the distance to the target.

In such FMCW radar systems, the accuracy of the distance measurement is largely dependent on the linearity of the frequency sweep. Consequently, several approaches have been adopted to improve it or to otherwise overcome sweep nonlinearity effects. For example, U.S. Pat. No. 4,958,161 is intended to precisely measure the overall phase difference of the beat signal between the instants t₁ and t₂ for a modulation of the transmitted frequency, between the frequencies f₁ and f₂, which is only approximately linear. The radar supplies a first beat signal Fb₁ between transmitted and received waves, and a second beat signal Fb₂ in quadrature with the first signal. The signals Fb₁ and Fb₂ are digitized, and, by means of successive increments/decrements, the number of zero crossings of the phase plane in a predetermined direction minus the number of zero crossings in the opposite direction, is derived therefrom The result is proportional to the calculated altitude h.

U.S. Pat. No. 7,982,661 discloses a coherent frequency modulated continuous wave (FMCW) radar. The radar includes a first discriminator for receiving a portion of the swept frequency signal and for producing a reference difference-frequency signal of frequency equal to the difference between the frequency of the swept frequency signal and the frequency of a time displaced swept frequency signal derived from the swept frequency signal. An analogue-to-digital converter is provided for sampling the target difference-frequency signal at a rate derived from the frequency of the reference difference-frequency signal. A processor is arranged to determine for at least one frequency component of the digitized target difference-frequency signal any phase difference between frequency sweeps of the swept frequency signal.

FMCW systems of a different type are employed for level gauge monitoring, for example for monitoring the level of a liquid in a tank. In such systems, the relatively small distances between the antenna and the target dictate different approaches from those adopted for altitude measurements in airplanes. In some systems a reference signal having a varying frequency is generated and the transmitted electromagnetic waves are produced as a function of the frequency of the reference signal. A second signal is then obtained from the electromagnetic waves reflected by the surface of the material and received by the antenna. The two signals should have substantially the same frequency, but different phases. A phase shift signal is then generated as a function of the phase differences between the reference signal and the second signal over the range of frequencies. The frequency of the phase shift signal is indicative of the distance travelled by the electromagnetic waves between the antenna and the surface of the material being monitored.

In such gauge measurements, the accuracy, and sometimes the validity of the measurement, may be impaired because the phase shift signal may include frequency components caused by reflections of the electromagnetic waves from surfaces other than the material being monitored (e.g. from the waveguide, from the sides of the tank, etc). U.S. Pat. No. 6,107,957 discloses a FMCW radar tank level gauge that measures a level in a tank by obtaining a set of phase shift data points of mixed transmitted waves and received waves. The set of spectral data phase shift values has a received target marker indicating the level. An adaptive set of masking threshold phase shift values corresponding to at least a portion of the spectral data phase shift values are calculated. The adaptive set of masking threshold values are compared with the corresponding spectral data values to identify at least one spectral data value associated with the level, the level of the tank being calculated therefrom.

### SUMMARY OF THE INVENTION

Aspects of the invention, in some embodiments thereof, relate to the field of layer thickness measurements. More specifically, aspects of the invention, in some embodiments thereof, relate to thickness measurements of layers of electrically isolating materials (e.g. polymeric materials) using frequency modulated, continuous electromagnetic waves.

According to an aspect of some embodiments there is provided a method for measuring a distance to a surface of an object. The method comprises obtaining an estimation d_{E} of the distance to the surface. The estimation of d_{E} may be obtained for example by a preliminary measurement of the distance. Additionally or alternatively, the estimation of d_{E} may be obtained for example by setting the distance to be equal, at least roughly, to d_{E}, as is explained and detailed further below. The method further comprises generating an electromagnetic continuous wave (EMCW) having a frequency in the range between about 100 MHz and about 1 THz, wherein the EMCW is frequency modulated so that the frequency thereof is controllably varied. Preferably, but not necessarily, the frequency is varied linearly using, for example, a saw-tooth modulation signal or a triangle modulation signal. The method further comprises transmitting a first portion of the EMCW towards the surface of the object and receiving a received signal from a reflection of the transmitted EMCW from the surface of the object. The method further comprises delaying a second portion of the EMCW by a controllably variable time delay ΔT, where ΔT is dictated by the estimation d_{E}, thereby generating a delayed signal. The method further comprises generating a combined signal by combining the received signal with the delayed signal, and measuring a parameter of the combined signal. The measured parameter of the combined signal may be according to some embodiments an amplitude, an intensity, a spectral distribution, a frequency or a phase, or any combination thereof. According to some embodiments, the method further comprises controllably varying ΔT, to equalize the frequencies, and/or to equalize the phases, of the received signal and the delayed signal.

According to some embodiments the delayed signal may be obtained by transmitting the second portion of the EMCW towards a reference surface located at a reference distance equal to d_{E}, and receiving a reflection of the transmitted second portion of the EMCW from the reference surface, so that the time delay ΔT is the travel time from transmission of the second portion of the EMCW to receiving the reflection thereof. According to some embodiments, varying time delay ΔT may thus be accomplished by controllably varying the distance of the reference surface, so that the travel distance of the transmitted second portion of the EMCW is varied, and hence the travel time is varied.

According to some embodiments, d_{E}, being an estimation of the distance D which is to be measured to the surface of the object, is roughly equal to D. Consequently, ΔT is roughly equal to the delay by which the received signal is delayed (relative to the transmitted signal, namely the first portion of the EMCW), hence the received signal and the delayed signal have roughly the same frequency. It is emphasized that if the time delay ΔT is equal exactly to delay by which the received signal is delayed, then the frequencies of the received signal and the delayed signal are identical, regardless of the time dependency of the frequency modulation of the EMCW. In other words, for any continuous frequency modulation (e.g. triangle, sinusoidal, saw-tooth (in the linear regime), etc.) the closer the time delays are, the closer are the frequencies of the delayed signal and the received signals; and when the time delays are equal, then the frequencies are equal. Thus, by equating, at least roughly, the time delay of the delayed signal with that of the received signal, influence of imperfections such as non-linearity or temporal fluctuations of the frequency modulation of the EMCW is reduced. Consequently, according to some embodiments, distance measurement with sub-wavelength accuracy may be achieved, using even frequency modulation that may deviate from perfect linearity, which requires in turn relatively simple and inexpensive circuitry.

As an illustrative, non-limiting example, a distance measurement to a planar surface of a measured polymer plate may be considered. The measured plate may be positioned at a distance D of about 5 cm from a bi-directional transmitting antenna, so that the planar surface and the antenna (in one of its transmission directions) are facing each other. A reference polymer plate may be positioned facing the other transmission direction of the antenna, at a distance d_{E} of about 5 cm from the antenna. An EM wave at a frequency sweeping between 74 GHz and 77 GHZ may be used, having a wavelength of about 4 mm Reflections of the transmitted signal from the measured plate and from the reference plate may be received by receiving antennas, respectively. The distances D and dE may readily be set equal, at least roughly, to each other, with an accuracy better than 4 mm, namely with an accuracy better than one wavelength of the EMCW used in the measurement, by any technique known in the art for positioning objects at distances of a few centimeters and with accuracy of a few millimeters. Consequently, the received signal (received from the surface of the measured plate) and the delayed signal (received from the reference plate) have substantially identical frequencies. By finely varying the distance of the reference plate from the respective transmitting antenna and/or the receiving antenna, the phases of the received signal and the delayed signal may be further equated, resulting substantially in equating the distances D and dE.

A similar measurement may be carried out for a back surface of the measured plate and a back surface of the reference plate, using respective reflections of the EMCW from these back surfaces. Such measurements may further obtain the respective distances to these back surfaces. From the two pairs of measurements, a thickness measurement of the measured plate, or a comparison of the thickness between the measured plate and the reference plate may be obtained. According to some embodiments, measurement at a sub-wavelength accuracy may be attained, as is further explained and detailed below. It is noted that EM waves are considerably more limited in penetrating electrically conducting materials compared to electrically isolating materials, hence only weak reflections of the EMCW—or practically no reflections at all—may be received from a back surface of an electrically conducting material such as a metal plate or such as electrically conducting fluid. However, an absolute attenuation of the EM wave in a conducting layer may be dependent on the total thickness of the layer and on the wavelength of the EM being used, and in some embodiments the method according to the teachings herein may also be used for thickness measurements of layers which are not entirely electrically isolating, or even for thickness measurements of layer of good conductors, particularly using wavelengths which are larger than the layer thickness.

According to an aspect of some embodiments there is further provided an apparatus for measuring a thickness of a layer in a tested object, the layer being defined between a front surface and a back surface. The apparatus comprises frequency-controlled electromagnetic continuous wave (EMCW) transmitter, configured to transmit in the range between about 100 MHz and about 1 THz, wherein the EMCW is frequency modulated so that the frequency thereof is controllably varied. The apparatus further comprises a transmitting antenna, functionally associated with the transmitter via a first splitter. The transmitting antenna is aligned and configured to transmit a portion of the EMCW signal, received from the splitter, towards the tested object. The apparatus further comprises a receiving antenna, aligned and configured to receive a reflection of the transmitted EMCW signal from the tested object. The apparatus further comprises a mixer, functionally associated with the splitter and with the receiving antenna, configured to mix a portion of the transmitted EMCW with a reflected signal received from the receiving antenna. The apparatus further comprises an analysis module, functionally associated with the mixer. The analysis module is configured to receive from a user estimations dE1 and dE2 of distances between the transmitting antenna and/or the receiving antenna to the front surface and the back surface, respectively. The analysis module is further configured to extract parameters P1, P2, . . . Pn of an output signal of the mixer, using the estimations dE1 and dE2. The analysis module is further configured to provide a measurement result of the thickness of the layer, using the parameters P1, P2, . . . Pn, wherein the thickness of the layer is defined as the difference D2−D1, wherein D1 is the distance between the transmitting antenna and/or the receiving antenna to the front surface and D2 is the distance between the transmitting antenna and/or the receiving antenna to the back surface of the layer.

Certain embodiments of the present invention may include some, all, or none of the above advantages. Further advantages may be readily apparent to those skilled in the art from the figures, descriptions, and claims included herein. Aspects and embodiments of the invention are further described in the specification hereinbelow and in the appended claims.

Unless otherwise defined, all technical and scientific terms used herein have the same meaning as commonly understood by one of ordinary skill in the art to which this invention pertains. In case of conflict, the patent specification, including definitions, governs. As used herein, the indefinite articles “a” and “an” mean “at least one” or “one or more” unless the context clearly dictates otherwise.

Embodiments of methods and/or devices herein may involve performing or completing selected tasks manually, automatically, or a combination thereof. Some embodiments are implemented with the use of components that comprise hardware, software, firmware or combinations thereof. In some embodiments, some components are general-purpose components such as general purpose computers or processors. In some embodiments, some components are dedicated or custom components such as circuits, integrated circuits or software.

For example, in some embodiments, portions of an embodiment may be implemented as a plurality of software instructions executed by a data processor, for example which is part of a general-purpose or custom computer. In some embodiments, the data processor or computer may comprise volatile memory for storing instructions and/or data and/or a non-volatile storage, for example a magnetic hard-disk and/or removable media, for storing instructions and/or data. In some embodiments, implementation includes a network connection. In some embodiments, implementation includes a user interface, generally comprising one or more of input devices (e.g., allowing input of commands and/or parameters) and output devices (e.g., allowing reporting parameters of operation and results).

### BRIEF DESCRIPTION OF THE FIGURES

Some embodiments of the invention are described herein with reference to the accompanying figures. The description, together with the figures, makes apparent to a person having ordinary skill in the art how some embodiments may be practiced. The figures are for the purpose of illustrative description and no attempt is made to show structural details of an embodiment in more detail than is necessary for a fundamental understanding of the invention. For the sake of clarity, some objects depicted in the figures are not to scale.

In the Figures:

FIG. 1 schematically depicts an embodiment of an apparatus for thickness measurements of a layer of material in a tested object, using a reference object having a layer of a known thickness;

FIG. 2A schematically depicts an embodiment of an arrangement of a transmitting antenna, a receiving antenna and lenses aligned for focusing transmission of EMCW according to the teachings herein, onto a surface of a tested object and reception therefrom;

FIG. 2B schematically depicts another embodiment of an arrangement of a transmitting antenna, a receiving antenna and lenses aligned for focusing transmission of EMCW according to the teachings herein, onto a surface of a tested object and reception therefrom;

FIG. 3 schematically depicts an embodiment of an apparatus for thickness measurements of a layer in a tested object, using a reference measurement using a mirror or two mirrors;

FIG. 4 schematically depicts an embodiment of an apparatus for thickness measurements of a layer in a tested object, using a reference signal and a controllably varied delay line;

FIG. 5 schematically depicts an embodiment of an apparatus for thickness measurements of a layer in a tested object without the use of reference (delayed) signals, and

FIG. 6 schematically depicts a method for measuring a thickness of a layer in a tested object according to the teachings herein.

### DETAILED DESCRIPTION OF SOME EMBODIMENTS

The principles, uses and implementations of the teachings herein may be better understood with reference to the accompanying description and figures. Upon perusal of the description and figures present herein, one skilled in the art is able to implement the teachings herein without undue effort or experimentation. In the figures, like reference numerals refer to like parts throughout.

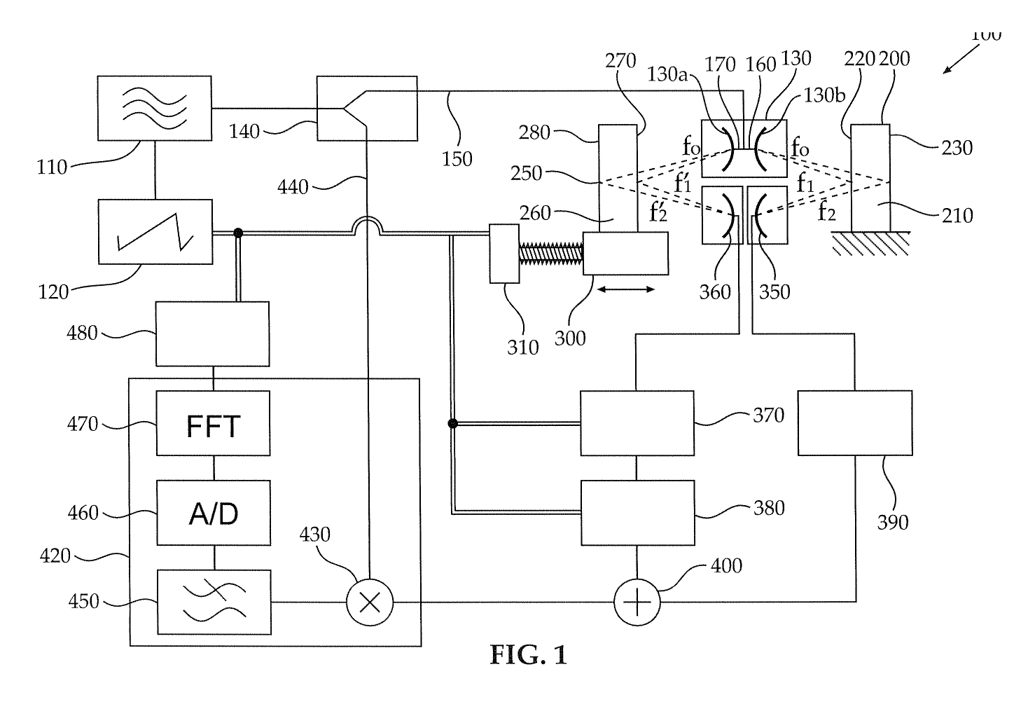

FIG. 1 schematically depicts an embodiment of an apparatus 100 for thickness measurements of layers, particularly (but not necessarily) of electrically isolating materials such as polymers, glass, ceramics and the like. The description herein relates to an illustrative example of a thickness measurement of a single layer; however a person skilled in the art may readily observe that the method may qualify and may be capable of providing thickness measurement of a desired layer in a multi-layer object, as is further explained below. The measurement described herein, according to some embodiments thereof, may be accomplished by comparison of the thickness of a measured layer (namely, a layer the thickness of which is unknown) to a known thickness of a reference layer. According to some embodiments, the method may be employed during a quality control test in a manufacturing process of an article incorporating the said layer, whereas a similar article having a standard layer with a known thickness, is used as a reference.

Apparatus 100 comprises an RF generator 110, configured for generating a radio-frequency (RF) electromagnetic (EM) continuous wave (CW) signal. RF frequency herein relates to a frequency that is generally higher than 100 MHz, and according to some embodiments between 1 GHz and 1 THz. RF generator 110 is further configured to vary the frequency of the generated EMCW signal according to a supplied modulation signal. A signal generator 120, configured to generate a modulation signal, is functionally associated with RF generator 110, for frequency modulating the generated EMCW signal. In operation, signal generator 120 may supply, according to some embodiments, a sweep modulation signal having a linear time-dependent portion, such as a saw-tooth signal or a triangle signal. However, apparatus 100 may be operated according to the teachings herein also with non-linear frequency modulation schemes, and accordingly signal generator 120 may generate a non-linear modulation signal such as a sinusoidal signal for frequency modulating the EMCW.

Apparatus 100 further comprises a bi-directional antenna 130, functionally associated with RF generator 110 through a splitter 140, for receiving from RF generator 110 a first portion 150 of the EMCW. Bi-directional antenna 130 is configured to transmit the first portion 150 of the EMCW received from RF generator 110 to two distinct directions. A measurement portion 160 of the EMCW is transmitted in a first direction whereas a reference portion 170 is transmitted in a second direction. It should be understood that bi-directional antenna 130 may be embodied in some embodiments by two separated antennas, a first transmitting antenna 130a and a second transmitting antenna 130b, which are configured and aligned to transmit to two different direction.

An object 200 such as a plastic plate, having a layer 210 of an electrically isolating material, may be positioned so as to measure a thickness of layer 210 between a front surface 220 and a back surface 230 thereof. Object 200 may be positioned so that front surface 220 faces bi-directional antenna 130 along the first direction. According to some embodiments object 200 may preferably be positioned so that front surface 230 is substantially perpendicular to the first direction, namely to the direction of transmission from bi-directional antenna 130. Likewise, a reference object 250 having a reference layer 260, preferably of a same material to that of layer 210, may be positioned facing bi-directional antenna 130 along the second direction. Reference layer 260 is defined between a reference front surface 270 and a reference back surface 280, and reference object 250 may be preferably positioned so that reference front surface 270 is substantially perpendicular to the second direction, namely to the direction of transmission from bi-directional antenna 130 towards reference object 250. It is noted that EM waves transmitted towards object 200 and towards reference object 250 may generate reflections from the front surfaces 220 and 270, respectively, of the objects, and from the back surfaces 230 and 280, provided that the refractive index n of the layer's material at the frequency of the EM being used, is substantially different from the refractive index of air.

Reference object 250 is positioned on a moving table 300, configured to be controllably displaced back and forth along the second direction by an actuator 310 such as a step motor. By controllably displacing moving table 300, the distance between bidirectional antenna 130 and reference object 250 (e.g. the distance to reference front surface 270) may be controllably varied. According to some embodiments of the method described herein, reference layer 260 in reference object 250 has a known thickness and is thus being used as a standard, to which layer 210 is being compared.

Apparatus 100 further comprises a receiving antenna 350 aligned and configured to receive reflections of the measurement portion 160 of the EMCW signal reflected from object 200. Apparatus 100 further comprises a reference receiving antenna 360 aligned and configured to receive reflections of the reference portion 170 of the EMCW signal reflected from reference object 250. According to some embodiments bi-directional antenna 130 may be employed as receiving antenna 350 for receiving reflections from object 200 along the first direction, and as a reference receiving antenna 360 for receiving reflections from reference object 250 along the second direction.

Apparatus 100 further comprises an adder 400, functionally associated with receiving antenna 350 and with reference receiving antenna 360. Adder 400 is configured to combine the received signal, received from receiving antenna 350, with the delayed signal received from reference receiving antenna 360, thereby obtaining a combined signal. Adder 400 is optionally functionally associated with reference receiving antenna 360 via a phase inverter 370 and via an attenuator 380. It is noted that the term attenuation is used herein in a most general meaning, referring to any (linear) change in an amplitude of the delayed signal, and including amplification. Hence, “attenuation” herein may comprise according to some embodiments, strict attenuation or amplification, and accordingly “attenuator” herein may comprise amplifier.

Phase inverter 370 is configured to controllably invert a phase of the signal received from reference receiving antenna 360. Attenuator 380 is configured to controllably attenuate the signal received from phase inverter 370. Adder 400 is functionally associated with receiving antenna 350, optionally via a compensator 390. Compensator 390 is configured to compensate for parasitic effects of attenuator 380 and phase inverter 370. Parasitic effects herein means intrinsic effects induced on the reference signal by the phase inverter and the attenuator, e.g. intrinsic attenuation, intrinsic time delay etc. For example, compensator 390 390 may be configured to delay the signal received from receiving antenna 350 by a fixed time delay DT0 and to attenuate the received signal by a fixed attenuation At0. The fixed time delay DT0 and the fixed attenuation At0 may be selected to be substantially equal to the total of the intrinsic time delays of phase inverter 370 and attenuator 380, and to their total attenuation, respectively (that is, when attenuator 380 is set to apply nominal zero attenuation) so that two signals leaving, respectively, receiving antenna 350 and reference receiving antenna 360 together, would arrive to adder 400 together with a similar amplitude.

Apparatus 100 further optionally comprises an analysis module 420 configured to analyze the combined signal from adder 400 and thereby assist in, or simplify performing a distance measurement and/or a thickness measurement using apparatus 100. Analysis module 420 may comprise a mixer 430 functionally associated with adder 400 to receive the combined signal therefrom. Mixer 430 is further functionally associated with splitter 140 to receive a second portion 440 of the EMCW therefrom. Mixer 430 is configured to multiply the signals received from splitter 140 and from adder 400, thereby obtaining low frequency output signal having a frequency equal to the difference of frequencies of the combined signal and of the second portion of the EMCW, and further obtaining a high frequency output signal having a frequency equal to the sum of frequencies of the combined signal and of the second portion 440 of the EMCW.

Analysis module 420 further comprises a low-pass filter 450 functionally associated with mixer 430, for filtering out the high frequency output signal of mixer 430. Analysis module 420 further comprises an analog-to-digital (A/D) converter 460 to digitize the remaining low frequency output signal, and a Fourier Transform module 470, configured to transform the low frequency output signal from the time domain to the frequency domain

Apparatus 100 optionally comprises a controller 480 comprising a processor (not shown in the Figure), controller 480 being configured to control some functionality of apparatus 100 and to provide a user-interface for allowing a user to activate and operate apparatus 100. Controller 480 may comprise user-interface devices and modules such as a screen display, a keyboard, a mouse etc., allowing a user to receive data from apparatus 100 and to provide commands thereto. Optionally, controller 480 is functionally associated with analysis module 420 for receiving data therefrom and for controlling analysis module 420; functionally associated with signal generator 120 for controlling the modulation signal, e.g. for controlling the frequency, amplitude and shape of the modulation signal; functionally associated with actuator 310 for controlling displacements of moving table 300; functionally associated with phase inverter 370 for controlling a phase inversion of the delayed signal; and functionally associated with attenuator 380 for controlling an attenuation of the delayed signal.

According to some embodiments, apparatus 100 may be used for measuring a distance to a surface of an object or to measure a thickness of a layer defined between a front surface and a back surface, by comparing an unknown distance or an unknown thickness to a known distance to a reference object or to a known thickness of reference layer, respectively, as is explained herein below.

In operation, the first portion 150 of the EMCW is transmitted by bi-directional antenna 130 in the first direction and the second direction towards object 200 and towards reference object 250, respectively. At an arbitrary instant during a working portion of the linear sweep period of the modulation signal (assuming a modulation having a positive ramp period) a signal having a momentary frequency f0 is transmitted simultaneously towards object 200 and reference object 250. At the same instant a received signal, which has been reflected from front surface 220, is received in receiving antenna 350, with a frequency f1, which is lower than f0. Also at the same time a delayed signal, which has been reflected from reference front surface 270, is received in reference receiving antenna 360, with a frequency f1′, which is also lower than f0. The relation between f1 and f1′, namely whether f1 is greater that f1′ or f1 is smaller that f1′ or whether f1 is equal to f1′, is determined upon the relative distances the waves travel from the bi-directional antenna 130 to the reflecting surfaces of the objects 200 and 250, and then to the receiving antennas 350 and 360, respectively. Likewise, a received signal, which has been reflected from back surface 230, is received in receiving antenna 350, with a frequency f2, which is lower than f1. Also at the same time a delayed signal, which has been reflected from reference back surface 270, is received in reference receiving antenna 360, with a frequency f2′, which is lower than f1′.

Ignoring, for the sake of simplicity of the explanation, phase inverter 370, attenuator 380 and delay line 390, the received signal and the delayed signal are combined by adder 400 to obtain a combined signal. The combined signal includes four instantaneous frequency components, namely f1, f1′, f2 and f2′, whereas f1 may generally be, at least roughly, equal to f1′, and f2 may generally be, at least roughly, equal to f2′. It is emphasized that the closer f1 to f1′ is, the closer are the travel lengths of the received signal and the delayed signal; and when the f1=f1′—or f2=f2′—than the travel lengths may be concluded to be equal.

The combined signal is mixed in mixer 430 with the second portion of the EMC, having substantially a frequency of f0. The low-frequency output signal obtained from mixer 430 and from low-pass filter 450 thus has the frequency components of the combined signal shifted down by f0, and explicitly f0−f1, f0−f1′, f0−f2 and f0−f2′.

As an illustrative, non-limiting example, a differential thickness measurement of an object 200—such as a polymer plate—having a thickness of e.g. about 1 cm may be considered. A differential thickness measurement is related herein to a measurement of a difference between a thickness of a measured object to a known thickness of a reference object. The measured plate may be positioned so that the front surface of the plate faces bi-directional antenna 130 at a distance D of about 5 cm from antenna 130. A reference polymer plate may be positioned facing the other transmission direction of bi-directional antenna 130, at a distance d_{E} of about 5 cm from the antenna. An EM wave at a frequency sweeping between 74 GHz and 77 GHZ may be used, having a wavelength of about 4 mm The modulation signal used may be a positive ramp saw-tooth signal, having a frequency of, e.g. about 10 KHz, resulting a sweep time—corresponding to the frequency sweep from 74 GHz to 77 GHZ—of about 0.1 msec.

Receiving antenna 350 and reference receiving antenna 360 may be positioned in proximity to bi-directional antenna 130, resulting in a travel distance of the reflections from the polymer plates to the receiving antennas of about 5 cm, respectively. Reflections of the transmitted signal from the measured plate and from the reference plate may be received by receiving antenna 350 and 360, respectively. The total travel time of the EMCW from transmission by bi-directional antenna 130 through reflections from the front surfaces of the plates is hence about 330 psec, corresponding to a frequency difference between f0 and f1 of about 10 KHz. Further, since the back surfaces of the plates are about 1 cm further away from the antennas (relative to the front surfaces) the frequency difference between f0 and f2 is about 12 KHz in the instant illustrative example. Furthermore, a deviation between the distances of e.g. the back surface 230 and the reference back surface 280 of about 0.1 mm, may result in a frequency difference between f2 and f2′ of about 20 Hz. It is noted that a frequency measurement such as the measurement of the difference between f0 and f1 or between f0 and f2 and so on—should be understood to include a phase measurement of the same signal(s). In other words, to perform an analysis to obtain the results described herein it may suffice to measure the phase (rather than to measure the frequency) of the difference signals. When a measurement of the phase of the difference between, say, f0 and f1 or between f0 and f2 or the difference between these two difference signals, then the rate of change of the measured phase indicates the related distance, e.g. the distance D to a reflecting surface, or the thickness of the reflecting layer. Thus, according to some embodiments, the phases of the signals at the output of filter 450 or A/D converter 460 are measured, rather than their frequencies.

According to some embodiments analysis module 420 may be used to facilitate and simplify a thickness measurement or a differential thickness measurement by enabling a spectrum analysis of the combined signal. The low-frequency output signal obtained from mixer 430 and from low-pass filter 450 may be digitized by D/A 460, and may be further transformed to the frequency domain by FFT module 470. The resulting spectrum may be displayed to a user on a display screen (not shown in the Figure) of controller 480.

According to some embodiments, a differential thickness measurement may thus proceed as follows.
(a) Reference front surface 270 is displaced, using moving table 300, to a distance dE which is an estimation of D, being roughly similar to D. Accordingly, as explained above, f1 and f1′ are roughly equal. Phase inverter 370 may be used to invert the phase of the delayed signal so that the delayed signal may cancel out the received signal in adder 400. Attenuator 380 may further be used to tune the amplitude of the delayed signal and hence to equalize the (absolute value of the) amplitude of the spectral component at f1 in the delayed signal to the (absolute value of the) amplitude of the spectral component at f1′ in the received signal, respectively. Displacing the front surface 270 and tuning the amplitude of the delayed signal may proceed iteratively or using any known method, to obtain cancelation of the received signal by the phase-inverted delayed signal at the said spectral region of f1. Such mutual cancelation signifying the identity of f1 and f1′, may manifest itself as zero amplitude signal at the frequency f0−f1 at an output of FFT module 470.
   It is noted that according to some embodiments of apparatus 100 and the method described herein, phase inverter 370 and attenuator 380 may be unnecessary, the use thereof may be avoided. According to some embodiments only the distance to reference front surface 270 is varied (using moving table 300) so as to equate f1′ to f1, whereas such equality is obtained when the combined signal at f1 is maximal.
(b) According to some embodiments, the position of moving table 300 may then be registered as a reference position or as a “Zero” position, identifying the equality of the distances to the front surface 220 and to the reference front surface 270, respectively.
(c) Step (a) above may be substantially repeated regarding the reflections from the back surface 230 and the reference back surface 280, to obtain mutual cancelation of the spectral components at f2 and f2′ in the received signal and the delayed signal, respectively. Reference back surface 280 may be displaced, using moving table 300, until f2 and f2′ are roughly equal. Phase inverter 370 may be used to invert the phase of the delayed signal so that the delayed signal may cancel out the received signal in adder 400 around the frequency f2 (it should be understood that a single phase inversion, namely of Pi radians, should be employed, in some embodiments, to the delayed signal, regardless whether to the spectral component at f1′ as described in step (a) or to the spectral component at f2′ as described in step (c)). Attenuator 380 may further be used to tune the amplitude of the delayed signal and hence to equalize the amplitude of the delayed signal to the amplitude of the received signal. Displacing the back surface 280 and tuning the amplitude of the delayed signal may proceed iteratively or using any known method, to obtain cancelation of the spectral component at f2 of the received signal by the phase-inverted spectral component at f2′ in the delayed signal. Such mutual cancelation signifying the identity of f2 and f2′, may manifest itself as zero amplitude signal at the frequency f0−f2 at an output of FFT module 470.
   It is further noted that reaching mutual cancelation of the spectral components of the delayed signal and the received signal at a specific frequency such as f1 or f2 as is described above, namely by displacing the moving table 300 and by varying the amplitude of the delayed signal, e.g. using attenuator 380, may be performed automatically using controller 480 and using a suitable computer program. A suitable program may be, according to some embodiments, a program configured to find a minimum of a dependent parameter (the amplitude of the combined signal at the specific frequency) as a function of several independent parameters (e.g. position of the moving table 300, attenuation or amplification of the delayed signal etc.).
(d) The distance (Delta)′ that the moving table 300 was moved from the “Zero” position to the position identified in step (c) above may be calculated using the difference (Delta) in thickness between the plate (object 200) and the reference plate (reference object 250). More precisely, the ratio between (Delta) and (Delta)′ is equal to the ratio of the speed V of the EMCW in the plate to the speed c of the EMCW in air:

Δd=Δd′/n
where Δd is the difference in thickness between the two plates, Δd′ is the distance the reference plate was displaced in step (c) above, and n is the refractive index of the plate's material at the wavelength of the EMCW, namely n=c/v, v being the speed of the EMCW in the plate and c is the speed of light in vacuum. Δd′ is assumed positive if the back surface of the reference object is displaced away from the antennas, indicating the measured plate having a thickness greater than the thickness of the reference plate (and consequently a positive Δd).

It is noted that thickness measurements of a desired layer in a multi-layer item may be accomplished similarly to the method described above, provided that necessary pre-conditions are satisfied as can be appreciated by the person skilled in the art. To enable such measurement in a multilayer material, the measured layer should typically be made from an electrically isolating material, whereas layer or layers between the measured layer and the transmitting antenna and the receiving antenna may preferably be also made of isolating materials, thereby enabling transmission of EM wave therethrough. To enable reflection from the front surface and from the back surface of the measured layer, the refractive index of the measured layer should be substantially different from the refractive indexes of the materials adjoining these surfaces.

According to some embodiments bi-directional antenna 130 may be configured and aligned to focus the transmitted EMCW onto object 200 along the first direction and onto reference object 250 along the second direction. In a typical layer thickness measurement of a layer thickness of a few centimeters or a few millimeters or even less, in an object located a few centimeters or a few millimeters away from the antenna, the EMCW may be focused to region (e.g. full width half maximum) of a few millimeters of even less than one millimeter. Likewise, receiving antenna 350 and reference receiving antenna 360 may be configured and aligned to receive reflections from object 200 along the first direction and from reference object 250 along the second direction from a focused region of similar dimensions of a few millimeters or even less than a millimeter, at similar distance as described above. Measuring a distance to point or limited region on a surface may provide higher reliability to the measurement, compared to a measurement associated with a large area of the surface. According to some embodiments, focusing the EMCW may be accomplished using lenses, e.g. Tsurupica lenses or polyethylene lenses as provided for example by Microtech Instruments, Inc. (http://www.mtinstruments.com/thzlenses/).

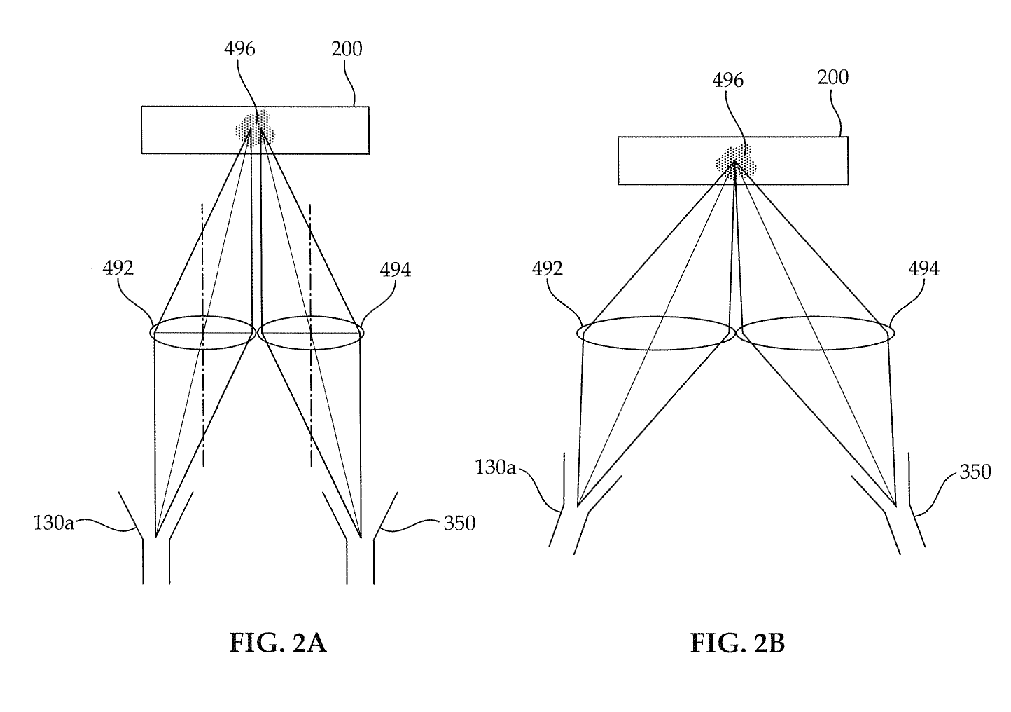

According to some embodiments lenses may be used to focus the transmission from bi-directional antenna 130 (e.g. from first transmitting antenna 130a) and the reception by receiving antenna 350 to a same point or a same region on object 200 wherein such transmission and reception are along directions which are not perpendicular to the front surface and back surface. Likewise, lenses may be used to focus transmission and reception to and from reference object 250 along directions which are not perpendicular to the reference surface and reference back surface thereof. FIG. 2A depicts schematically an arrangement suitable for use as part of apparatus 100, comprising a first lens 492 and a second lens 494, both positioned in front of object 200 and aligned to have their optical axes parallel to each other. First transmitting antenna 130a and receiving antenna 350 (configured e.g. as horn antennas or funnel antennas) are aligned parallel to each other so as to transmit and receive, respectively, along directions parallel to each other and parallel to the optical axes of first lens 492 and second lens 494. Transmitting antenna 130a is positioned off-axis relative to first lens 492, and receiving antenna 350 is positioned off-axis from second lens 494. Consequently EMCW transmission from transmitting antenna 130a is focused onto a region 496 of object 250 through first lens 492 substantially along directions that are not perpendicular to the surfaces of object 200, and reflections from region 496 are focused onto receiving antenna 350 through second lens 494 substantially along directions that are not perpendicular to the surfaces of object 200. For example, lenses 492 and 494 may have a diameter of about 50 mm and a focal length of about 60 mm The antennas and object 250 may be arranged at equal distances of about 120 mm from the lenses, on both sides of the lenses, respectively, providing a numerical aperture (half beam width) of about 12 degrees. When transmission or reception directions are not perpendicular to the object surfaces, the propagation direction of the EMCW inside the layer is also not perpendicular to the surfaces, and calculation of the passage time of the wave inside the layer defined by the surfaces must take into account the angle by which such directions are diverted from the orthogonal to the surfaces, according to the index of refraction of the layer's material, as is well known in the art.

FIG. 2B schematically depicts an arrangement suitable for use as part of apparatus 100 and different from the arrangement of FIG. 2A, in that the antennas 130a and 350 are aligned so that the directions of transmission and reception, respectively, are not parallel and intersect on object 200.

According to some embodiments, transmission towards the object 200 and reception thereform may be accomplished using a single transmit/receive antenna as is well known in the art of RF radiation. For example, receiving antenna 350 may be used for transmission towards object 200 and for receiving reflections thereform. According to some such embodiments, receiving antenna 350 may be associated with splitter 140 and with compensator 390 via a circulator (not shown in this figured) the circulator being used to direct a transmission signal from splitter 140 to receiving antenna 350 and to direct a signal from receiving antenna 350 to compensator 390. Likewise transmission towards reference object 250 and reception therefrom may be accomplished using a single transmit/receive antenna, e.g. reference receiving antenna 360.

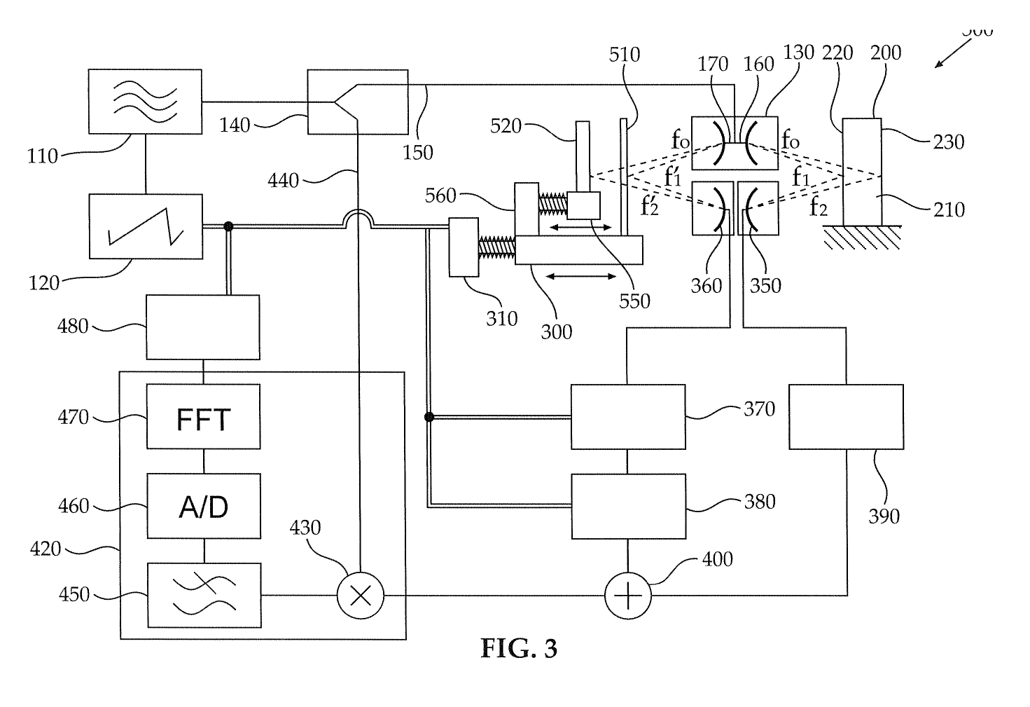

FIG. 3 schematically depicts an embodiment of an apparatus 500, different from apparatus 100, for thickness measurements of layers of materials (the materials being preferably electrically isolating as explained above). For simplicity purpose, the description herein relates to measuring a single layer, however thickness measurement of a desired layer in a multi-layer object may be similarly accomplished as will be appreciated by the person skilled in the art.

Apparatus 500 is different from apparatus 100 in using a half mirror 510 and a mirror 520 instead of reference object 250. Half mirror 510 and mirror 520 are positioned facing bi-directional antenna 130 along the second direction of transmission, optionally so that each mirror is substantially perpendicular to the said second direction. In operation, the thickness of object 200 is compared to the distance between half mirror 510 and mirror 520. Half mirror 510 is made as a thin sheet, being semi-transparent at the RF frequency being used for the EMCW. Accordingly, half mirror 510 is configured to reflect part of the EMCW impinging thereon, whereas another part of the EMCW passes through the half mirror towards mirror 520. Reflections from mirror 520 pass, at least partially, through half mirror 510 to be received by reference receiving antenna 360.

Half mirror 510 is positioned on moving table 300, so that, by controllably displacing moving table 300, the distance between bidirectional antenna 130 and half mirror 510 may be controllably varied. Apparatus 500 further comprises secondary moving table 550, on which mirror 520 is positioned. Secondary moving table 550 is configured to be controllably displaced back and forth along the second direction of transmission from bi-directional antenna 130 by a secondary actuator 560 such as a step motor. Secondary actuator 560 is configured to displace secondary moving table 550 relative to moving table 300, so that a displacement of secondary moving table 550 varies the distance between half mirror 310 and mirror 520.

In operation, half mirror 510 and mirror 520, analogously to reference front surface 270 and reference back surface 280 in FIG. 1, reflect reflections of the reference portion 170 of the transmitted EMCW, the reflections having frequencies of f1′ and f2′, respectively. Consequently, half mirror 510 and mirror 520 may be displaced, optionally (but not necessarily) simultaneously, to generate a delayed signal having frequencies f=f1 and f2′=f2, so as to cancel out, in adder 400, the received signal from receiving antenna 250.

For a thickness measurement of object 200, half mirror 510 may be displaced and the attenuation of attenuator 380 may be varied, substantially as described in step (a) above, so that f1′=f1. Equality of f1 and f1′ may indicate that the distance the wave travels from bi-directional antenna 130 in the first direction of transmission to front surface 220 of object 200 and then to receiving antenna 350, is equal to the distance the wave travels from bi-directional antenna 130 antenna in the second direction of transmission to half mirror 510 and then to reference receiving antenna 360. The position of half mirror 510 may then be registered, e.g. in a computer's memory, as a reference or a “Zero” position.

Likewise, mirror 520 may be displaced by moving secondary moving table 560, and the attenuation of attenuator 380 may be varied, substantially as described in step (c) above, so that f2′=f2. Equality of f2 and f2′ may indicate that the total travel time of the wave from bi-directional antenna 130 in the first direction of transmission to back surface 230 of object 200 and then to receiving antenna 350, is equal to the total travel time of the wave from bi-directional antenna 130 in the second direction of transmission to mirror 520 and then to reference receiving antenna 360. Because the velocity of the wave in air (between half mirror 510 and mirror 520) may be different from the velocity of the wave in the layer 210, the thickness of layer 210 is related to the distance between half mirror 510 and mirror 520 through the refractive index n of the material of the layer. According to some embodiments a thickness of half mirror 510 is very small and negligible relative to the distance between half mirror 520 and mirror 520, and the thickness of the measured layer may be calculated according to

d=d′/n,

where d is the thickness of the measured plate, d′ is the distance between half mirror 520 and mirror 510, and n is the refractive index of the measured plate's material at the wavelength of the EMCW, as explained above.

A similar formula and calculation may be employed to calculate the thickness of the measured material if only a single mirror (e.g. such as mirror 520) is used. The mirror may be positioned first at a first position, denoted as “Zero”, so that f1=f1′ as explained above, and then moved by a distance d′ away from bi-directional antenna 130 so that f2=f2′.

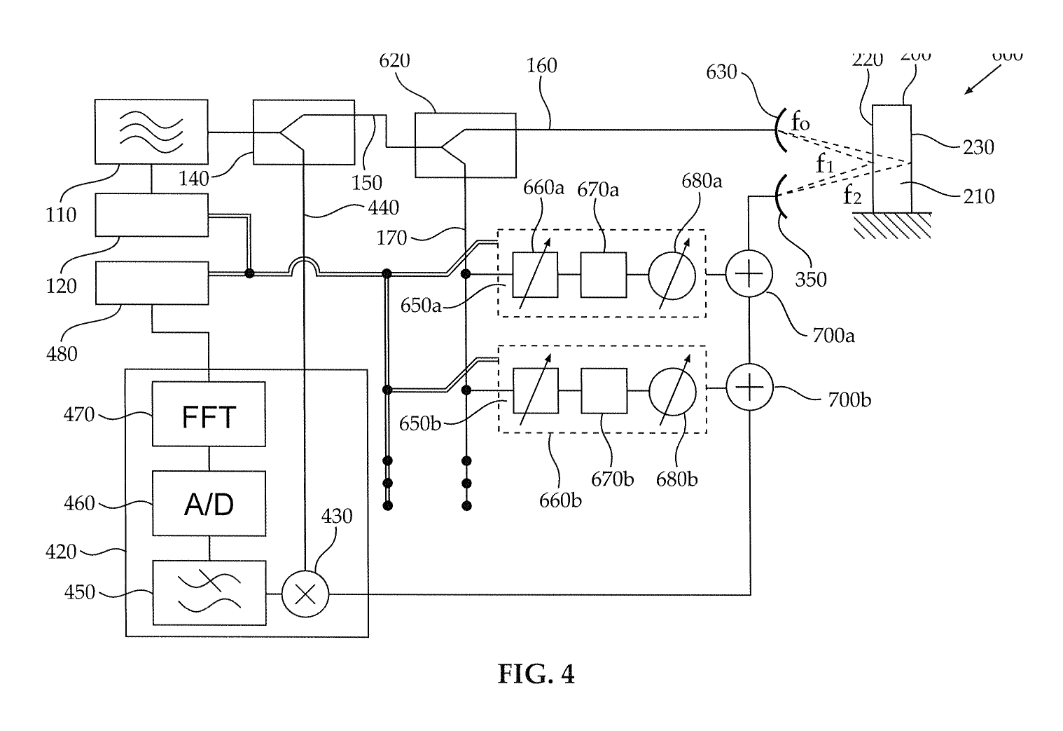

FIG. 4 schematically depicts an embodiment of an apparatus 600, different from apparatus 100, for thickness measurements of layers of materials, the materials being possibly electrically isolating as explained above. Apparatus 600 is different from apparatus 100 in using delay lines instead of reference object 250 for generating the delayed signal. For simplicity purpose, the description herein relates to measuring a single layer, however thickness measurement of a desired layer in a multi-layer object may be similarly accomplished as will be appreciated by the person skilled in the art.

Apparatus 600 comprises a second splitter 620, functionally associated with RF generator 110 through splitter 140 for receiving from RF generator 110 first portion 150 of the EMCW. Second splitter 620 splits the first portion of the EMCW to measurement portion 160 delivered to a transmitting antenna 630, and to reference portion 170 used to generate the delayed signal.

Transmitting antenna 630 is configured to transmit the measurement portion of the EMCW towards object 200, whereas object 200 is positioned having the front surface 220 thereof facing transmitting antenna 630, optionally perpendicular to the direction of transmission. Receiving antenna 350 is aligned and configured to receive reflections of the measurement portion 160 of the EMCW signal reflected from object 200, specifically from the front surface 220 and from the back surface 230 thereof.

Apparatus 600 further comprises a delay branch 650a for generating a first delayed signal from the reference portion 170 of the EMCW received from second splitter 620. Delay branch 650a comprises a controllably variable delay line 660a functionally associated with second splitter 620 for receiving at least a portion of reference portion 170. Delay branch 650a further optionally comprises a phase inverter 670a and an attenuator 680a, functionally associated in series with variable delay line 660a. Delay branch 650a is thus configured to generate the first delayed signal from the reference portion 170 of the EMCW, whereas the first delayed signal is controllably delayed relative to the reference portion of the EMCW signal by the time delay imposed by variable delay line 660a. The first delayed signal may further optionally be controllably attenuated (or amplified) and phase inverted relative to the reference portion 170, by attenuator 680a and by phase inverter 670a, respectively.

Apparatus 600 further comprises an adder 700a functionally associated with delay branch 650a for receiving the first delayed signal therefrom, and with receiving antenna 350 for receiving the received signal therefrom Similarly to adder 400 in FIG. 1, adder 700a is configured to combine the received signal with a first delayed signal received from delay branch 650a thereby obtaining a first combined signal.

In operation, the received signal in adder 700a has a frequency f1, whereas the first delayed signal in adder 700a has a frequency f1′. f1′ may be varied by varying the time delay imposed by variable delay line 660a. Equating f1′ to f1 may be carried out by equating the total time delay Tt of the first delayed signal (relative to the reference portion of the EMCW signal, having a frequency f0), imposed by delay branch 650a, to the time of travel of the measurement portion 160 from transmitting antenna 630 to object 200 and then to receiving antenna 350. Consequently, by knowing the total time delay Tt and by considering the speed of the EMCW in air, the distance to object 200 (e.g. to the front surface thereof) may be concluded.

According to some embodiments, apparatus 600 optionally comprises a second delay branch 650b, comprising a second variable delay line 660b, a second phase inverter 670b and a second attenuator 680b. Accordingly, a second delayed signal, delayed (relative to the reference portion 170) by a time delay generally different from that imposed by delay branch 650a, may be generated. Further, apparatus 600 optionally comprises a second adder 700b functionally associated with adder 700a and with second delay branch 650b. Adder 700b is configured to combine the first combined signal with the second delayed signal to generate a second combined signal. It should be appreciated by the person skilled in the art that multiple delay branches may be comprised by apparatus 600, similarly to delay branch 650a and delay branch 650b, to generate multiple delayed signals at arbitrary time delays. Apparatus 600 may further comprise multiple adders, e.g. 700c, 700d etc., each being used to add a delayed signal obtained by one delay branch to a combined signal obtained from another adder of the apparatus. Each delay branch may generate a delayed signal having a desired time delay, thus providing one more spectral component to the combined signal. For example, in the specific embodiment of apparatus 600, having two delay branches 650a and 650b, the combined signal may include substantially two spectral components related to delayed signals, f1′ and f2′, respectively and, generally, four spectral components (assuming a single layer object 200), namely f1, f1′, f2 and f2′.

Apparatus 600 may be used to measure the thickness of layer 210 in object 200 by comparing the travel time of the EMCW transmitted towards the object and reflected from the front surface 220 and back surface 230 thereof, to the delay time imposed to the delayed signals by the delay branches 650a and 650b. According to some embodiments, a method for such a measurement may be carried out as follows:
(1) The distance D1 to the front surface 220, and the distance D2 to the back surface 230 are estimated by associated estimations dE1 and dE2 respectively. Initial time delays, imposed by delay lines 660a and 660b, respectively, are accordingly established, so that first time delay dt1=2d_{E1/c} and a second time delay dt2=2d_{E2/c}. The combined signal in an operative apparatus 600 is analyzed in the frequency domain, as is explained above, to identify the spectral components f1 and f2, associated with reflections from the front surface 220 and back surface 230, respectively, of layer 210. The combined signal is further analyzed to identify the spectral components f1′ and f2′, associated with the delays imposed by delay branches 650a and 650b, respectively.
(2) The time delay imposed by variable delay line 660a may be varied so as to equalize f1′ with f1. Likewise, the time delay imposed be variable delay line 660b may be varied so as to equalize f2′ with f2.
(3) The distance to front surface 220 may be calculated using the first time delay dt1 imposed by delay branch 650a and the distance to back surface 230 may be calculated using the second time delay dt2 imposed by delay branch 650b. The difference dt2−dt1 is equal to the total travel time of the EMCW inside layer 210, between front surface 220 and back surface 230. In some embodiments this total travel time of the EMCW inside layer 210 is the time for travel substantially back and forth, in a trajectory substantially perpendicular to the front surface and the back surface of the layer.
(4) By considering the velocity v of the EMCW inside the material of layer 210, the thickness d of the layer may be calculated as

$$d = \frac{( dt 2 - dt 1 )}{2} \cdot v$$

It is noted that, using a single delay branch only, a thickness measurement may be carried out by equating the frequency of the delayed signal f′ to one spectral component of the received signal, e.g. to f1, using the variable delay line 660a, and registering the related time delay dt1. It is emphasized that employing a single delay branch 650a only, results in the delayed signal having a single spectral component only. Then the frequency of the delayed signal f′ may be equated to the other spectral component of the received signal, e.g. to f2, by further varying the time delay of variable delay line 660a, and registering the related time delay dt2. The thickness of the measured layer may then be concluded as described above in steps (3) and (4).

It is further noted that the methods described above may be performed manually or automatically, e.g. using a designated software and a related computer, or may be performed as a combination of manual and automatic steps. According to some embodiments, controller 480 may be programed to perform one or more of the following steps:
receive the combined signal, e.g. from one of the adders 700 (e.g. from adder 700a) or receive a low-frequency output signal, e.g. from mixer 430. The controller may preferably receive such a signal in the frequency domain, e.g. following an FFT transformation.
Identify the frequency or frequencies of the received signals from the measured object (such as object 200). Identifying a spectral component as belonging to the received signal or to the delayed signal may be accomplished by one of several techniques, for example turning of the delayed signal, e.g. by imposing high attenuation in attenuator 680a and identifying the remaining spectral components. Or alternatively identifying the spectral components of the delayed signal by turning of the transmission from antenna 630. And the like.
Identify the frequency or frequencies of the delayed signal.
Vary the time delay or time delays associated with the delayed signals, e.g. by varying the variable delay lines 660a and 660b until a frequency f′ (or a phase) of the delayed signal is equal to a frequency f (or a phase) of the received signal.
Calculate a distance to the measured object and/or to surfaces thereof and/or a thickness of a layer in the measured object, defined between two surfaces of the object.

According to some embodiments, equating the frequencies of the delayed signal to the frequencies of the received signal may be carried out by varying the amplitude and the frequency of a phase-inverted delayed signal (by varying the total time delay imposed by variable delay line 660) and the attenuation thereof (e.g. using attenuator 680), to obtain cancelation of the received signal by the delayed signal. According to some embodiments equating the frequencies may be carried out by varying only the time delay to obtain a maximum combined signal at the frequency f1 (or f2) of the received signal. According to some embodiments varying parameters of the delayed signal to obtain an extremum of a parameter of the combined signal may be carried out using any suitable method known in the art for extremum seeking. An example of such a suitable method may use an extended Newton-Raphson method for finding a root of a multi-variable function. Examples for the parameters that may be varied are the time delay which is varied by the variable delay line, or attenuation (or amplification) which may be varied by the attenuator. According to some embodiments, the process of varying two or more time delays to equate two or more frequencies of the delayed signal to frequencies of the received signal, may be performed simultaneously. The description hereinabove of automatically controlling the apparatus, equating spectral components of the received signal and the delayed signal and thereby finding a distance to a reflecting surface or a thickness of a layer between two reflecting surfaces may be employed mutatis mutandis with apparatus 500 and apparatus 100 described above.

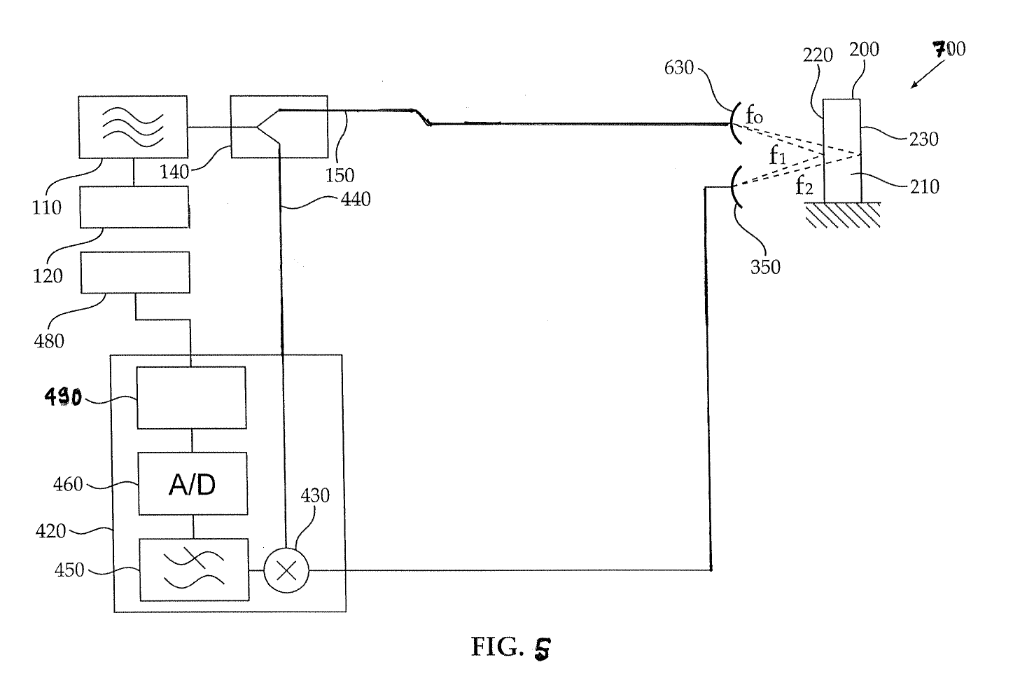

FIG. 5 schematically depicts an embodiment of an apparatus 700, different from apparatus 600, for thickness measurements of layers of materials, the materials being possibly electrically isolating as explained above. Apparatus 700 is different from apparatus 600 in avoiding generating delayed signals for combining with the received signals, and particularly avoiding using delay lines and/or the use of delay branch 650 for producing such delayed signals. In apparatus 700, the received signal from receiving antenna 350 (substantially associated with reflected electromagnetic waves from both front surface 220 and back surface 230) are directly mixed in mixer 430 with second portion 440 of the EMCW. The mixed signal, possibly after passing through low-pass filter 450 and after being converted by A/D converter 460, is processed by signal processor 490. Signal processor 490 may be used, according to some embodiments, to extract simultaneously the parameters of the low-frequency output signal obtained from mixer 430 and from low-pass filter 450. According to some embodiments, signal processor 490 may be employed to extract the frequency of the difference signal, namely the difference frequencies f0−f1 and f0−f2; and/or the amplitude of the difference signal and/or the phase of the difference signal. According to some embodiments a user may input to controller 480 estimated values dE1 and dE2 for the distances to front surface 220 and to back surface 230, respectively, and controller 480 can provide signal processor 490 in analysis module 420 with estimated parameters (e.g. estimated frequencies or estimated phase values) which are associated with such estimated distances.

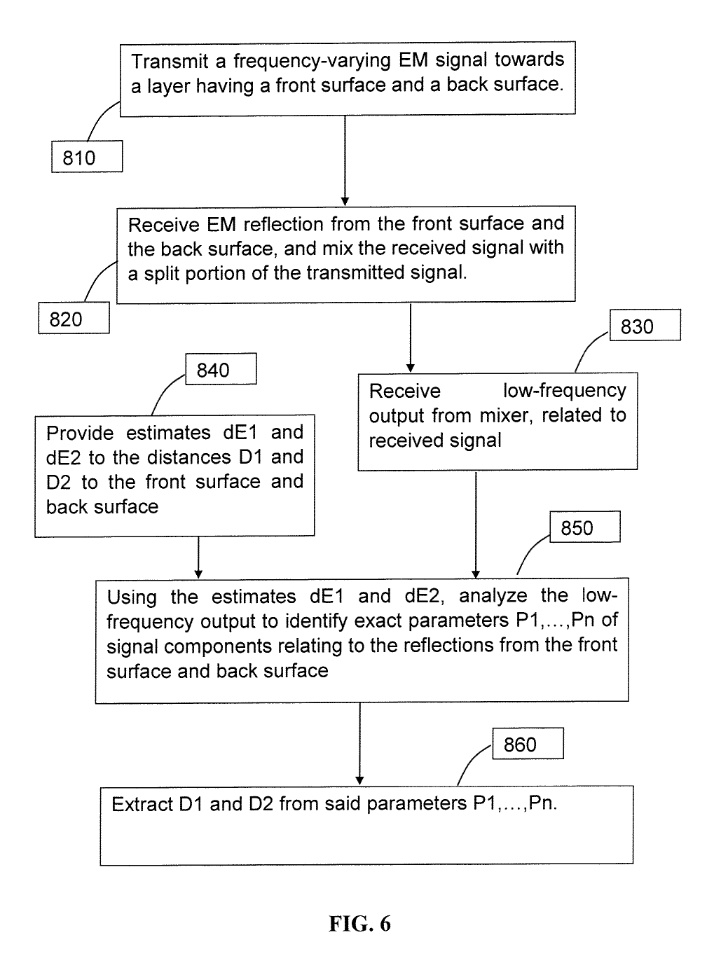

FIG. 6 schematically depicts a method for measuring a thickness of an electrically isolating layer according to the teachings herein. Step 810 comprises transmitting a frequency-varying EM signal towards the layer. The transmitted signal may have a linearly varying frequency (over a pre-defined range) as described herein above. Step 820 may include receiving an EM reflection from the front surface and the back surface, and mixing in a mixer the received signal with a portion of the transmitted signal.

Step 830 comprises receiving in the signal processor from the mixer's output, a low-frequency component of the mixed signal. The low frequency component typically comprises spectral components having frequencies that equal to the difference between the frequency of the transmitted signal and the frequency of the received signals (from both surfaces of the layer).

Step 840 comprises providing to the signal processor estimates dE1 and dE2 of the distances D1 and D2 to the front surface and the back surface. Providing these estimates is particularly important and beneficial because it simplifies and facilitates the process of establishing a valid measurement, as further detailed below. In step 850 the signal processor uses the estimates dE1 and dE2 to analyze the low frequency output of the mixer and thereby to extract parameters P1, P2, . . . , Pn, of the signal components relating to the reflections from the from surface and from the back surface. Such parameters P1, . . . Pn may be for example the frequency difference between the transmitted signal and a first reflection and between the transmitted signal and a second reflection. According to some embodiments a fit process may be utilized in which a parameters-controlled artificial spectrum is compared to the received low-frequency components of the mixer's output. By varying the parameters to obtain a best fit, the parameters of the received signal may be extracted, namely revealed. It should be understood that providing (e.g. by the user) estimates dE1 and dE2 of the final results of D1 and D2 respectively, may greatly facilitate obtaining of these results.

In step 860 the distances D1 and D2 are extracted from the revealed directly from the parameters P1, P2, . . . , Pn. For example, if the said parameters stand for the frequency difference between the transmitted signal and the received signals then the distances D1 and D2 are calculated as described herein above, e.g. in FIG. 1. It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. No feature described in the context of an embodiment is to be considered an essential feature of that embodiment, unless explicitly specified as such.

Although steps of methods according to some embodiments may be described in a specific sequence, methods of the invention may comprise some or all of the described steps carried out in a different order. A method of the invention may comprise all of the steps described or only a few of the described steps. No particular step in a disclosed method is to be considered an essential step of that method, unless explicitly specified as such.

Although the invention is described in conjunction with specific embodiments thereof, it is evident that numerous alternatives, modifications and variations that are apparent to those skilled in the art may exist. Accordingly, the invention embraces all such alternatives, modifications and variations that fall within the scope of the appended claims. It is to be understood that the invention is not necessarily limited in its application to the details of construction and the arrangement of the components and/or methods set forth herein. Other embodiments may be practiced, and an embodiment may be carried out in various ways.

The phraseology and terminology employed herein are for descriptive purpose and should not be regarded as limiting. Citation or identification of any reference in this application shall not be construed as an admission that such reference is available as prior art to the invention. Section headings are used herein to ease understanding of the specification and should not be construed as necessarily limiting.

1. A method for measuring a distance to a surface of an object using an electromagnetic continuous wave (EMCW), the method comprising:
obtaining an estimation d_{E} of the distance to the surface;
generating an electromagnetic continuous wave (EMCW) having a frequency in the range between about 100 MHz and about 1 THz, wherein the EMCW is frequency modulated so that the frequency thereof is controllably varied;
transmitting a measurement portion of the EMCW towards the surface of the object;
receiving a received signal from a reflection of the transmitted EMCW from the surface of the object;
generating a combined signal by combining the received signal with a delayed signal, the delayed signal being obtained by delaying a reference portion of the EMCW by a controllably variable time delay ΔT, ΔT being dictated by d_{E}, and
measuring a parameter of the combined signal,
thereby measuring the distance to the surface of the object.

2. The method of claim 1 wherein the estimation dE is known to differ from the distance to the surface of the object by no more than one wavelength of the EMCW.

3. The method of claim 1 further comprising iteratively varying ΔT and measuring a parameter of the combined signal.

4. The method of claim 3 further comprising varying ΔT so as to equate a frequency of a spectral component of the delayed signal with a frequency of a spectral component of the received signal.

5. The method of claim 1 wherein said combining comprises adding the received signal with the delayed signal.

6. The method of claim 4 wherein said combined signal is mixed with a portion of the EMCW to obtain a mixed signal having a frequency component below 100 MHz.

7. The method of claim 6 wherein said mixed signal is filtered using a low-pass filter having a cut-off frequency below 100 MHz.

8. The method of claim 1 wherein measuring a parameter of the combined signal includes measuring at least one parameter from the group consisting of: amplitude, intensity, spectral distribution, frequency and phase.

9. The method of claim 1 wherein delaying the reference portion of the EMCW to obtain the delayed signal is accomplished by transmitting the reference portion of the EMCW towards a reference surface located at a reference distance equal to d_{E}, and receiving a reflection of the transmitted reference portion of the EMCW from the reference surface to obtain the delayed signal.

10. The method of claim 9 wherein the reference distance is controllably varied to vary ΔT.

11. The method of claim 1 wherein delaying the reference portion of the EMCW to obtain the delayed signal is accomplished by using a variable delay line.

12. The method of claim 1, further including a step of measuring the time delay ΔT.

13. The method of claim 1 wherein the delayed signal is obtained by further controllably amplifying or attenuating the reference portion of the EMCW.

14. The method of claim 1 wherein the method comprises measuring a frequency distribution of the combined signal and further comprises tuning the time delay ΔT to equalize the frequency of the received signal and the delayed signal.

15. A method for measuring a thickness of a layer of a material, defined between a front surface and a back surface, the method comprising:
generating an electromagnetic continuous wave (EMCW) having a frequency in the range between about 100 MHz and about 1 THz, wherein the EMCW is frequency modulated so that the frequency thereof is controllably varied;
transmitting a measurement portion of the EMCW towards the front surface and the back surface of the layer;
receiving a received signal having a first spectral component from reflections of the transmitted EMCW from the front surface and a second spectral component reflections from the back surface of the layer;
generating a delayed signal by delaying a reference portion of the EMCW by a time delay ΔT, ΔT being controllably variable, and
varying ΔT to equate a frequency of the delayed signal to a frequency of the first spectral component of the received signal.
varying ΔT to equate a frequency of the delayed signal to a frequency of the second spectral component of the received signal.
thereby measuring the thickness of the layer between the front surface and the back surface.

16. The method of claim 15 wherein the material is electrically isolating.

17. A method for measuring a thickness of a layer of a material, defined between a front surface and a back surface, the method comprising:
generating an electromagnetic continuous wave (EMCW) having a frequency in the range between about 100 MHz and about 1 THz, wherein the EMCW is frequency modulated so that the frequency thereof is controllably varied;
transmitting a measurement portion of the EMCW towards the front surface and the back surface of the layer;
receiving a received signal including a first component from reflections of the transmitted EMCW from the front surface and a second component from reflections from the back surface of the layer;
mix a portion of the transmitted EMCW with the received signal from the receiving antenna thereby obtaining a mixed signal;
receive from a user estimations dE1 and dE2 of distances between the transmitting antenna and/or the receiving antenna to the front surface and the back surface of the layer, respectively;
using said estimations dE1 and dE2, extracting parameters P1, P2, . . . Pn of a low-frequency component of said mixed signal, and
using said parameters P1, P2, . . . Pn, calculating a measurement result of the thickness of the layer.

18. An apparatus for measuring a thickness of a layer, defined between a front surface and a back surface in a tested object, the apparatus comprising:
a frequency-controlled electromagnetic continuous wave (EMCW) transmitter, configured to transmit in the range between about 100 MHz and about 1 THz, wherein the EMCW is frequency modulated so that the frequency thereof is controllably varied;
a transmitting antenna, functionally associated with said transmitter via a first splitter, and aligned and configured to transmit a portion of said EMCW signal towards said tested object;
a receiving antenna, aligned and configured to receive a reflection of said transmitted EMCW signal from said tested object;
a mixer, functionally associated with said splitter and with said receiving antenna, configured to mix a portion of said transmitted EMCW with a reflected signal received from said receiving antenna, and
an analysis module, functionally associated with said mixer and configured to:
receive from a user estimations of distances dE1 and dE2 between the transmitting antenna and/or the receiving antenna to the front surface and the back surface, respectively;
using said estimations dE1 and dE2, extract parameters P1, P2, . . . Pn of a low-frequency component of an output signal of said mixer, and
using said parameters P1, P2, . . . Pn, provide a measurement result of said thickness of the layer.
